(19) United States
(12) Patent Application Publication
(10) Pub. No.: US 2022/0279749 A1
(43) Pub. Date: Sep. 8, 2022

(54) Raised Cat Litter Box Storage and Modular System

(71) Applicants: Amy Leiker, Lenexa, KS (US); Jody J. Allen, Valley Falls, KS (US)

(72) Inventors: Amy Leiker, Lenexa, KS (US); Jody J. Allen, Valley Falls, KS (US)

(21) Appl. No.: 17/687,599

(22) Filed: Mar. 4, 2022

Related U.S. Application Data
(60) Provisional application No. 63/156,875, filed on Mar. 4, 2021.

(51) Int. Cl. A01K 1/01; A47B 81/00

(52) U.S. Cl. CPC A01K 1/0107; A47B 81/00

(57) ABSTRACT

A raised cat litter storage system which is raised/elevated and provides a one stop station for cat owners to be able to store and use all things pertaining to cat litter usage in one module with a raised/elevated open cat litter box above an enclosed storage area. The module is created from two solid side walls, a solid bottom, a rear wall with small cut out for cords, two front double doors swinging open from the center with each respective door being hinged to the nearest adjacent side wall, and two top double doors swinging open from the center with each respective door being hinged to the nearest adjacent side wall creating an animal perch and open access to the litter box located on the internal single shelf. The top doors are hinged, but also removably attached so the invention can be configured in a plurality of manners.

### FEDERALLY SPONSORED RESEARCH

Not Applicable

### SEQUENCE LISTING OR PROGRAM

Not Applicable

### TECHNICAL FIELD OF THE INVENTION

The present invention relates to a litter box storage system. More specifically, the present invention relates to an elevated or raised open litter box storage system in combination with a modular furniture system construction.

### BACKGROUND OF THE INVENTION

Many pet owners are older adults with common disabilities such as arthritis or osteoarthritis that often makes bending over and kneeling difficult, especially with advancing age. An older pet owner caring for pets, especially cats or other pets with a litter box need or requirement, the need for frequently bending and kneeling is increased.

Current enclosed or cabinet/furniture type cat litter systems or boxes are made for the litter box to be on the lower level and are enclosed making access difficult, whereas the real solution to eliminating bending over is for the litter box to be located in a raised or lifted position, preventing the cat owner from having to bend over and to provide open access to the litter box.

As a result of older cat owners and those with arthritic conditions facing increasing diminished ability to provide care for their pets, many solutions have been created to reduce this issue, such as complex, mechanical litter box lifting systems, and long handled litter scoops, each which have their disadvantages.

Lifting and automated systems are generally expensive to purchase and do not always result in eliminating the need to bend over to replace new or used litter.

Long handled scoops and other solutions are often difficult to operate and require a certain level of dexterity that is commonly diminishing in older adults who represent a large number of care providers for cats. The need for and lack of proper dexterity often results in spills or messes that then result in the user having to bend over or get on their knees to clean up, or additional work with a sweeper or broom, which also provides stress to the back and knees. Cat owners who cannot bend over or get on their knees are unable to thoroughly clean the litter box, leaving the owner and cat living with potential health hazards.

Therefore, what is needed is a solution for raising a litter box to a higher level, which still allows easy access to a cat, even a cat with heath or mobility issues, as well as providing an elevated location to reduce or eliminate the need for a care provider to bend over or lower to their knees to clean and replace litter.

Additionally, what is needed is not only a means for raising the litter box, but for also providing storage containment and privacy during use, which can be accomplished through the use of a specifically designed, functional furniture device having a one or more modular pieces and using one or more shelving and door configurations.

Finally, what is needed is a raised cat litter storage system which is: elevated so that the litter remains out of the reach of small children; elevated so that it is out of reach of other pets, such as dogs; elevated to eliminate cat owners from having to bend down, and provides for storing or locating cat necessities all in one place, so that it is tidy, concealed and offers mobility for both cats and cat owners.

### SUMMARY OF THE INVENTION

The present invention is a raised or elevated open cat litter box storage and modular system created from one or more basic modular components or modules. A module is comprised of and created from two solid side walls, a solid bottom, a rear wall with cut out for electrical cords, and a front wall with front double doors swinging open from the center with each respective door being attached to the nearest adjacent side wall.

A single shelf is located approximately halfway up the back and side walls and the top doors open to provide a platform on each side of the side walls. The shelf, which can be manufactured as fixed or removeable using standard adjustable cabinet shelving techniques creates an open box location or recess for the insertion of a litter box, with open and free access by a pet.

When the front double doors are open, access is provided to a lower shelf area or recess, which is sealed off when the doors are in a closed position, creating an area for storage of extra cat litter, and other cat related necessities, such as trash can, trash bags, toys, or any related objects.

The present invention can be configured in various configurations, the two top doors can be opened to act as a perch for the animal, the two top doors can be completely removed, or the two top doors can be arranged in a configuration with one door removed and the other in a closed or open position to act as a perch for the animal.

In yet another embodiment, a fold out perch connected to the front wall of the cabinet can be folded into an open or external position, creating access and rest or exit/entry points.

In an alternative embodiment, the two top doors can be removed, and the front panel can include a top open section to provide additional access space to the recessed area and open litter box. In this embodiment, the front perch if affixed to the front panel and the lower section of the opening at the top of the front panel.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a singular component of the modular litter box system of the present invention with two front doors and two top doors in closed positions.

FIGS. 2-3 illustrate a singular component of the modular litter box system of the present invention with closed top doors and one open front door and one closed front door.

FIG. 4 illustrates a singular component of the modular litter box system of the present invention with closed top doors and both front doors in an open position.

FIG. 5 illustrates a singular component of the modular litter box system of the present invention with both top doors in an open position and both front doors in a closed position.

FIGS. 6-7 illustrates a singular component of the modular litter box system of the present invention with one top door in an open position acting as a perch for the animal, one top door removed, and both front doors in a closed position.

FIGS. 8-9 illustrate a singular component of the modular litter box system of the present invention with both top doors in an open position acting as perches for an animal and both front doors in an open position.

FIG. 10 illustrates a singular component of the modular litter box system of the present invention with both top doors in an open position acting as perches for an animal, the hinged perch in an open or external position, and both front doors in an open position.

FIG. 11 illustrates a singular component of the modular litter box system of the present invention with both top doors in an open position acting as perches for an animal and the hinged perch in an open or external position.

FIG. 12 illustrates a singular component of the modular litter box system of the present invention with both top doors removed and the hinged perch in an open or external position.

FIG. 13 illustrates a singular component of the modular litter box system of the present invention with both top doors removed and the hinged perch in a closed or internal position.

FIGS. 14-18 illustrates an alternative embodiment of the present invention where a singular component of the modular litter box system of the present invention is shown featuring a cut out front wall portion, and a fixed position perch.

FIG. 19 illustrates the lower underside portion of the modular litter box system where trim is attached the walls to create a recess for adding a plurality of wheels and to create a matching recess to the outer top surface of the modular litter box system so that they can be placed in a stacked position.

FIGS. 20-21 illustrate the modular litter box system in a two stack arrangement.

### LIST OF REFERENCE CHARACTERS

1. Side wall

2. Side wall

3. Solid bottom

4. Rear/back wall

5. Front Double Door

6. Front Double Door

7. Top Double Door

8. Top Double Door

9. A recessed, elevated/raised cat litter box storage system

10. Single shelf

11. Open top box location

12. Litter box

13. Front Perch

14. Box

15. Front Wall

16. Top of Side Wall

17. Top of Side Wall

18. Front Perch

19. Opening

20. Protective Shield

21. Wall/Shield

22. Wall/Shield

23. Wall/Shield

24. Hood

25. Side Walls

26. Side Walls

27. Underside of the box floor

28. Trim

29. Walls

30. Wheels

31. Wheels

32. Wheels

33. Wheels

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized, and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, the device is understood that the invention may be practiced without these specific details. In other instances, well-known structures and techniques known to one of ordinary skill in the art have not been shown in detail in order not to obscure the invention.

The present invention is a modular furniture solution for raising a litter box to a higher level, which still allows easy access to a cat, even a cat with heath or mobility issues, as well as providing an elevated location to reduce or eliminate the need for a care provider to bend over or lower to their knees to clean and replace litter.

The present invention teaches a raised cat litter storage system which is: elevated so that the litter remains out of the reach of small children; elevated so that it is out of reach of other pets, such as dogs; elevated to eliminate cat owners from having to bend down, and provides for storing or locating cat necessities all in one place, so that it is tidy, concealed and offers mobility for both cats and cat owners.

The present invention is designed to raise standard sized litter boxes up and off the floor by at least two (2) ft. Standard sized litter boxes can be inserted in the platform or recess of the module taught by the present invention. Standard sized new litter boxes maybe stored and enclosed as well below within the modular system.

The various configurations and combinable modular system provide not only a means for raising the litter box, but for also providing storage, containment, and privacy during use, which is accomplished through the use of the specifically designed, functional furniture device/modular having a one or more modular pieces and using one or more shelving, door, wheels, and top lid configurations.

The present invention teaches making a one stop station for cat owners to be able to store and use all things pertaining to cat litter usage. The present invention teaches the use of a raised for easier maintenance/cleaning. Once the cat litter box storage system is set up with an owner's preferred items, the cat litter box storage system is easy to store items needed to maintain a tidy bathroom/loo for the cat to use and its owner to keep tidy.

Also, by teaching an embodiment of the present invention with wheels, the present invention can be used to move all items from room to room, all at one time. From delivery spot to desired area. It is a multi-tool, for cat owners.

The cat litter box storage system of the present invention teaches a raised modular cat litter box storage system. The multipurpose unit is designed to be used in small living spaces as well as easy access for cats and owners, always allowing for more to be added, in various ways.

The cat litter box storage system of the present invention creates a maintenance area for cat owners to ensure the bathroom area is clean, and store various tools, all either concealed or open depending upon the owner's preferences.

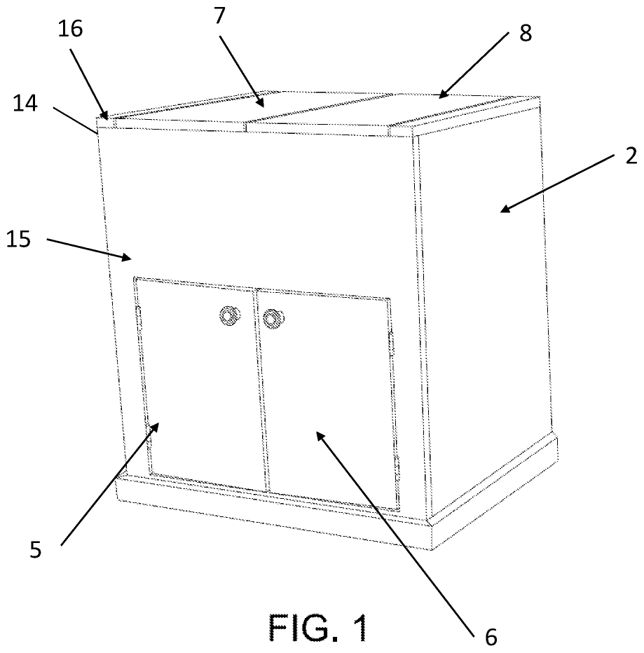

Now referring to FIG. 1, a singular component of the modular litter box system of the present invention is illustrated. In this embodiment, the basic modular component is illustrated. The module is created from two solid side walls 1 and 2, a solid bottom 3, a rear/back wall 4 with small cut out for cords, two front double doors 5 and 6 swinging open from the center with each respective door being hinged to the nearest adjacent side wall, and two top double doors 7 and 8 swinging open from the center with each respective door being hinged to the nearest adjacent side wall 1 or 2. The top doors 7 and 8 are hinged, but also removably attached.

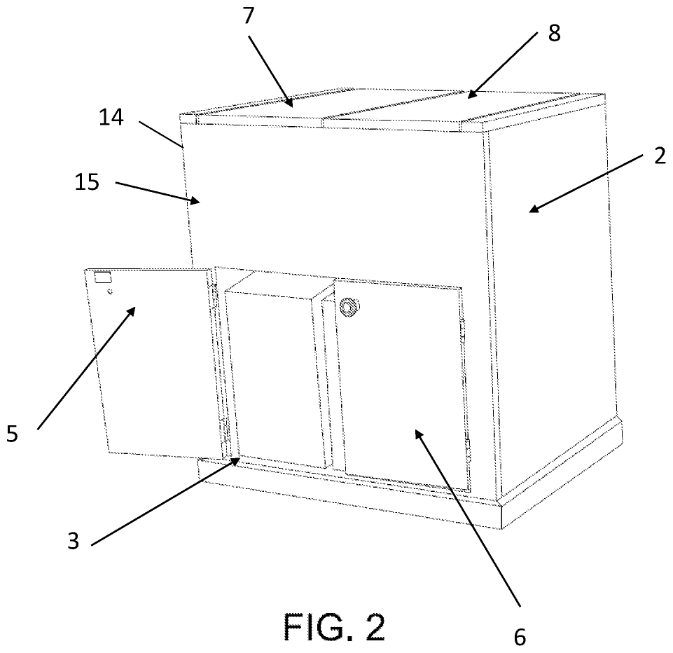

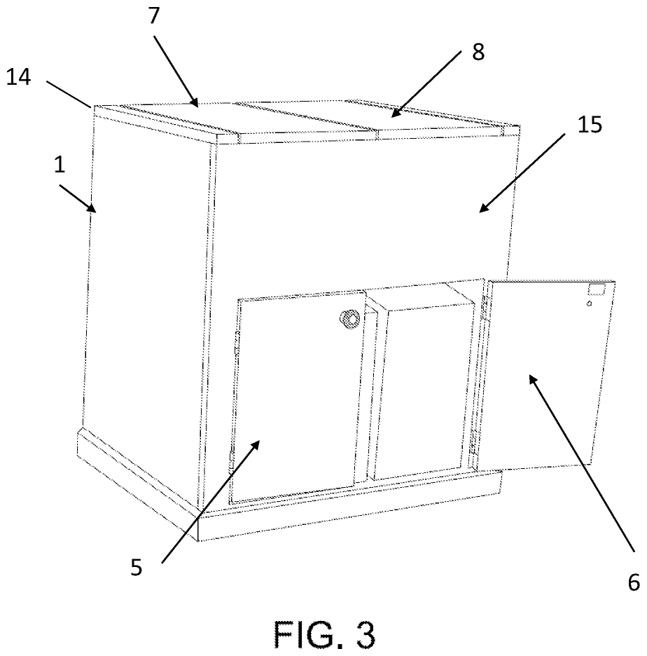

FIGS. 2-3 illustrate a singular component of the modular litter box system of the present invention with closed top doors 7 and 8 and one open front door 5 and one closed front door 6. In this embodiment, a single shelf 10 is located approximately halfway up the back/rear side wall 4 and side walls 1 and 2 and two top doors 7 and 8 are shown in a closed position, but may alternatively be in an open position, or one open and one closed position. The single shelf 10, which can be manufactured in a fixed, adjustable, or removable location using standard adjustable cabinet shelving techniques creates an open box location 11 for the insertion of a litter box 12, with open and free access by a pet. The single shelf 10 and open top box location 11 create a recessed, yet elevated/raised cat litter box storage system 9.

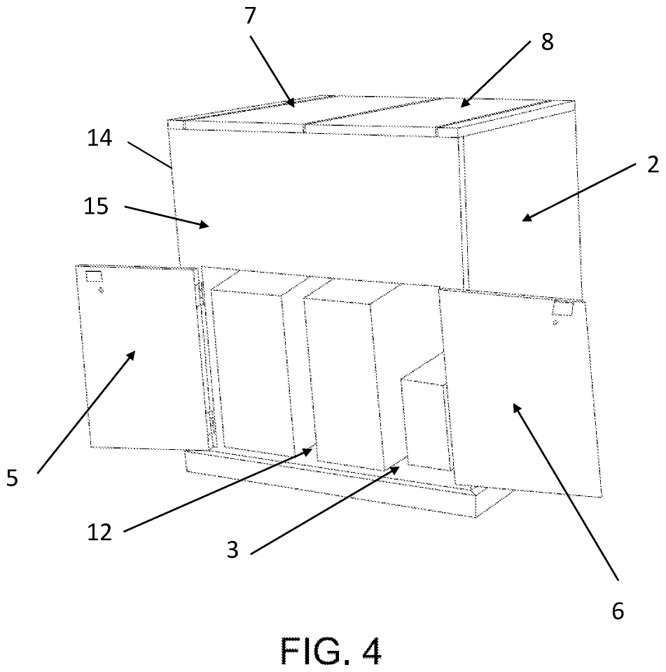

FIG. 4 illustrates a singular component of the modular litter box system of the present invention with closed top doors 7 an 8 and both front doors 5 and 6 in an open position. When the front doors 5 and 6 are open, access is provided to a lower shelf area 12, which is sealed off when the front doors 5 and 6 are in a closed position, creating an area for storage of extra cat litter, bags, toys, bedding, a trash can, pooper scooper, or any other related or desired objects.

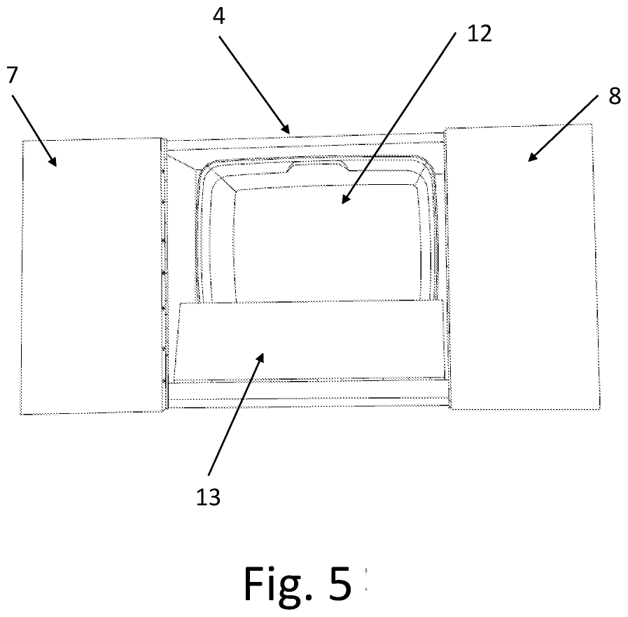

FIG. 5 illustrates a singular component of the modular litter box system of the present invention with both top doors 7 and 8 are in an open position and both front doors 5 and 6 are in a closed position. The foldable front perch 13 is attached to the front wall 15 of the box 14 using a hinge and is easily folded or rotated out for use as a perch for an animal or stored to allow the unit to be stacked with another until in an alternative embodiment. The front perch 13, like the top doors 7 and 8 is attached is a manner, like a hinge or piano hinge, that also allows for quick detachment and removal.

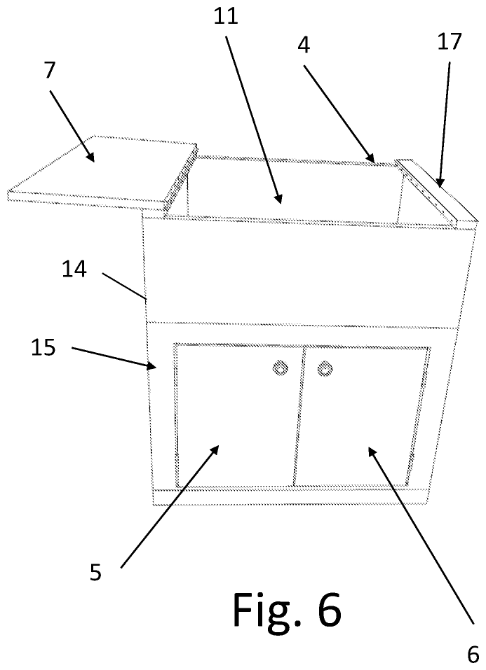

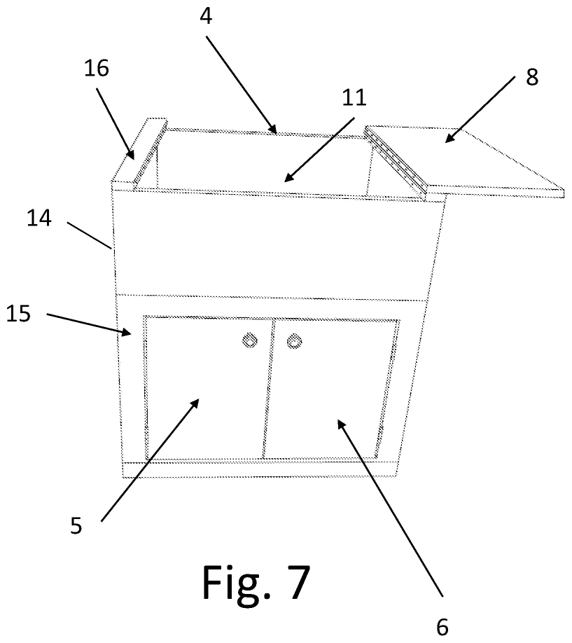

FIGS. 6-7 illustrates a singular component of the modular litter box system of the present invention with one top door 7 in an open position acting as a perch for the animal and the other top door removed, and both front doors 5 and 6 in a closed position. As shown, either of the top doors 7 and 8 can be removed individually or as a pair. In this embodiment it is preferred to remove one door and place the remaining door into an open position to act as a perch for the animal.

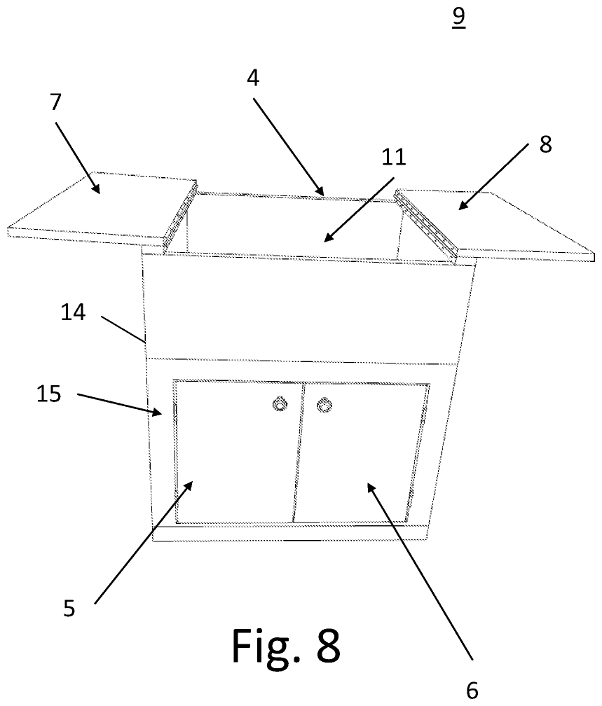

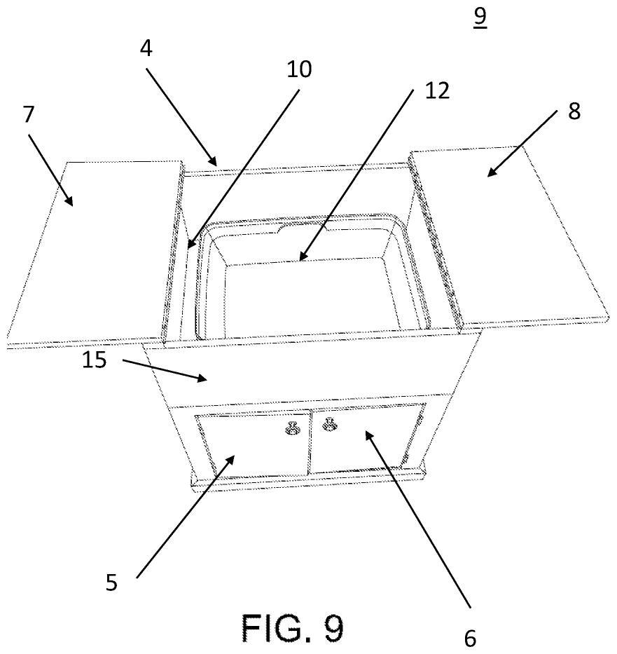

FIGS. 8-9 illustrate a singular component of the modular litter box system of the present invention with both top doors 7 and 8 in an open position acting as perches for an animal and both front doors 5 and 6 in an open position. In these figures, the heart of the invention is shown, that being a raised/elevated open litter box, with one or more perches for an animal providing open access to the litter box in an elevated or raised position off the floor.

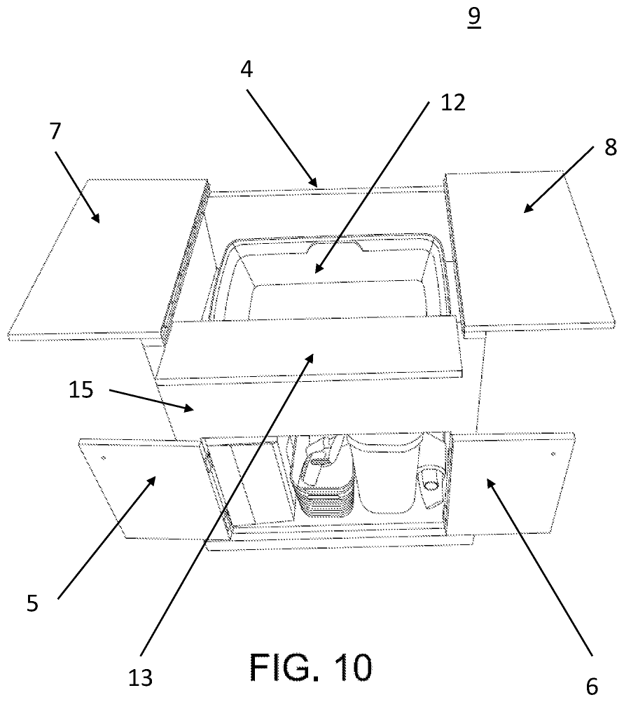

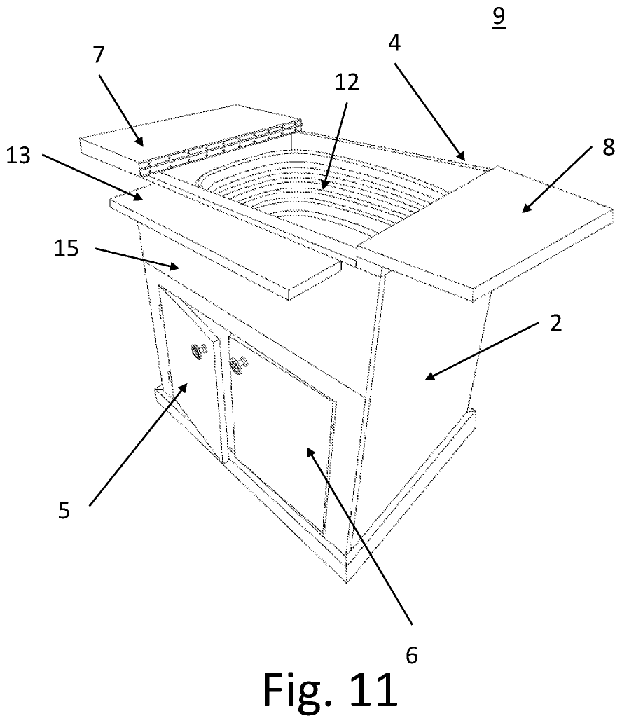

FIGS. 10-11 illustrates a singular component of the modular litter box system of the present invention with both top doors 7 and 8 in an open position acting as perches for an animal, the hinged front perch 13 in an open or external position, and both front doors 5 and 6 in an open position. In this embodiment, all three potential animal perches are shown and in position for use. The two top doors 7 and 8 have been placed into the open position to act as perches and the front perch 13 has been folded into an open position for use as a perch to allow an animal three sides of access to the raised/elevated open litter box.

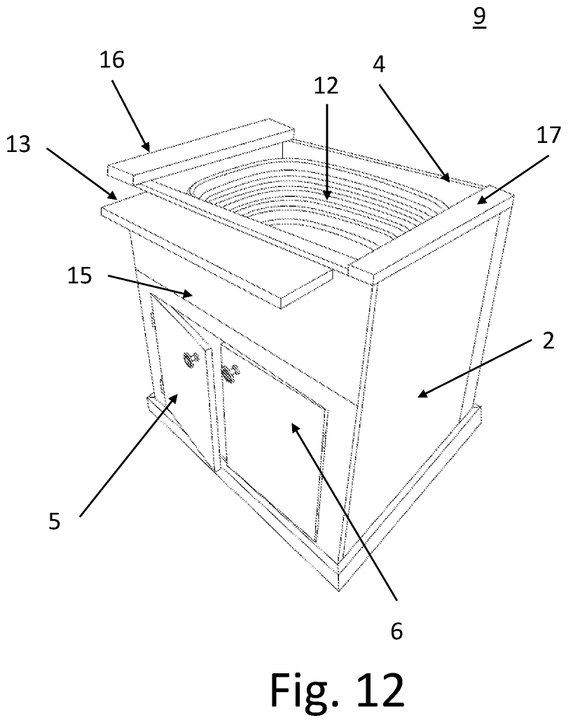

FIG. 12 illustrates a singular component of the modular litter box system of the present invention with both top doors 7 and 8 are removed and the hinged perch 13 is in an open or external position. Here the top doors 7 and 8 have been removed eliminating two of the three animal perches, but still allowing open access to the raised/elevated litter box by an animal or a user.

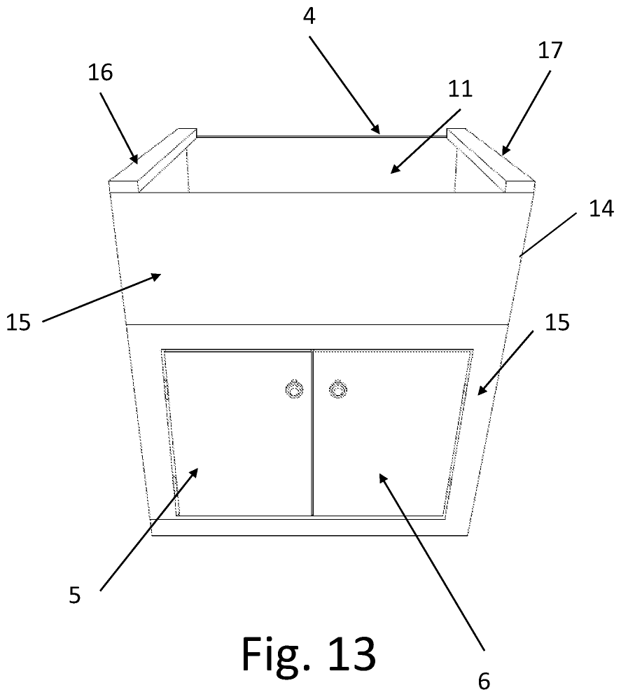

FIG. 13 illustrates a singular component of the modular litter box system of the present invention with both top doors 7 and 8 removed and the hinged perch 13 in a closed/internal position or removed. If desired, the front perch 13 can be placed or left in a closed or internal position or removed completely. Here, the top doors 7 and 8 and front perch 13 have been removed, with the top of the side walls 16 and 17 acting as an animal perch, providing open access to the raised/elevated litter box by an animal or person.

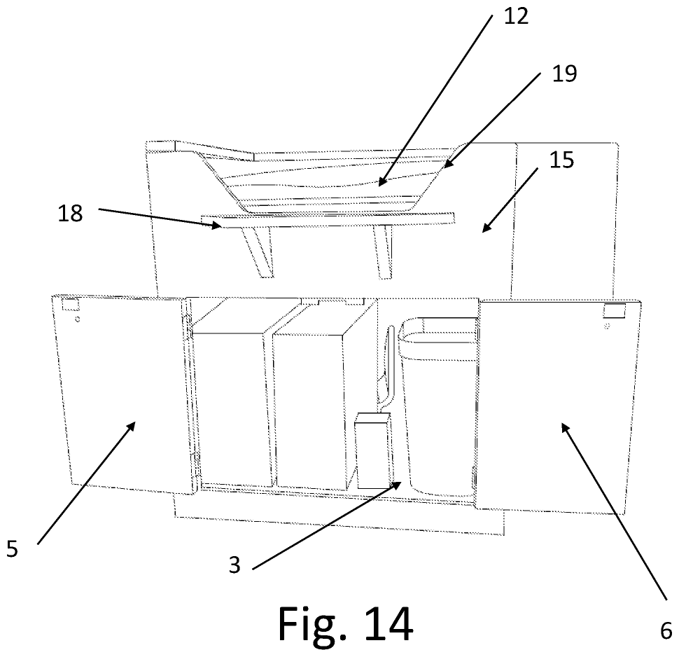

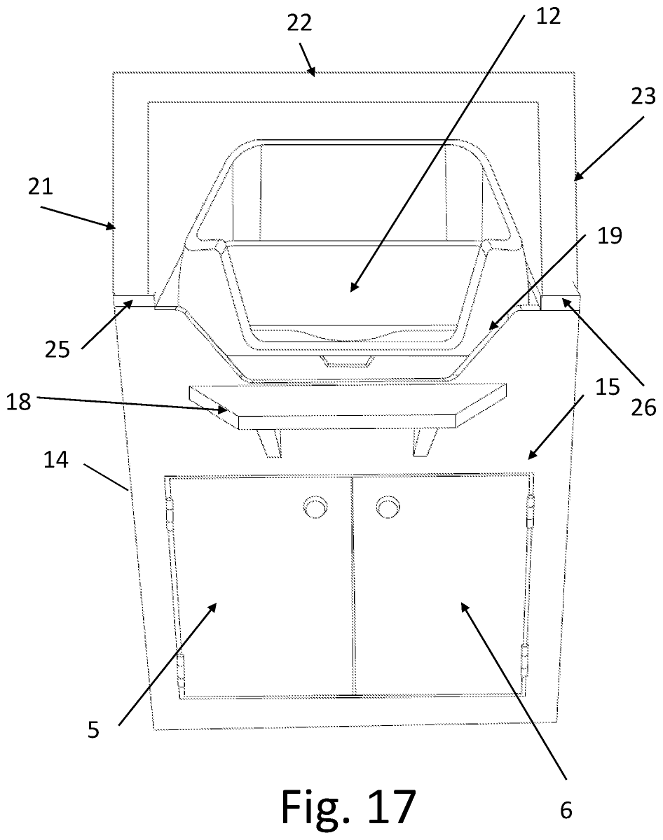

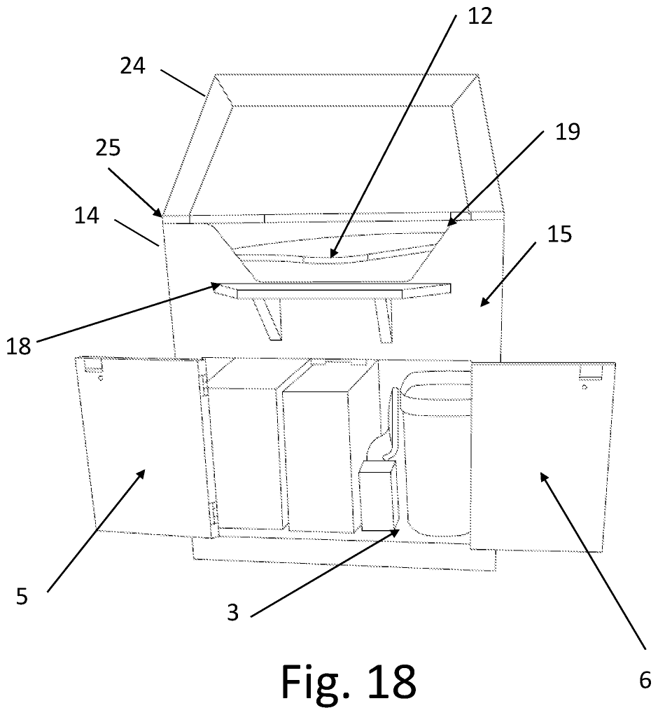

FIGS. 14-18 illustrates an alternative embodiment of the present invention where a singular component of the modular litter box system of the present invention is shown featuring a cut out front wall portion, and a fixed position perch.

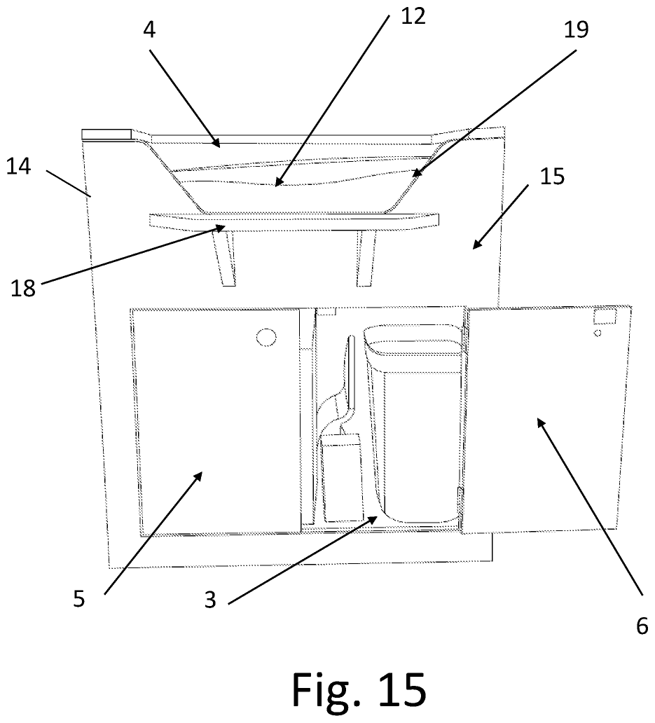

In this embodiment, the basic modular component is illustrated. Now referring to FIGS. 14-15, the module is created from two solid side walls 1 and 2, a solid bottom 3, a rear wall 4 with small cut out for cords, two front double doors 5 and 6 swinging open from the center with each respective door being hinged to the nearest adjacent side wall 1 and 2, and a fixed front perch 18. The front wall 15 is further comprised of an opening 19 providing easier access to the raised/elevated litter box by an animal or a user for easier cleaning. Below the opening 19 a front perch 18 is mounted in a fixed potion providing a perch and access to the litter by for an animal.

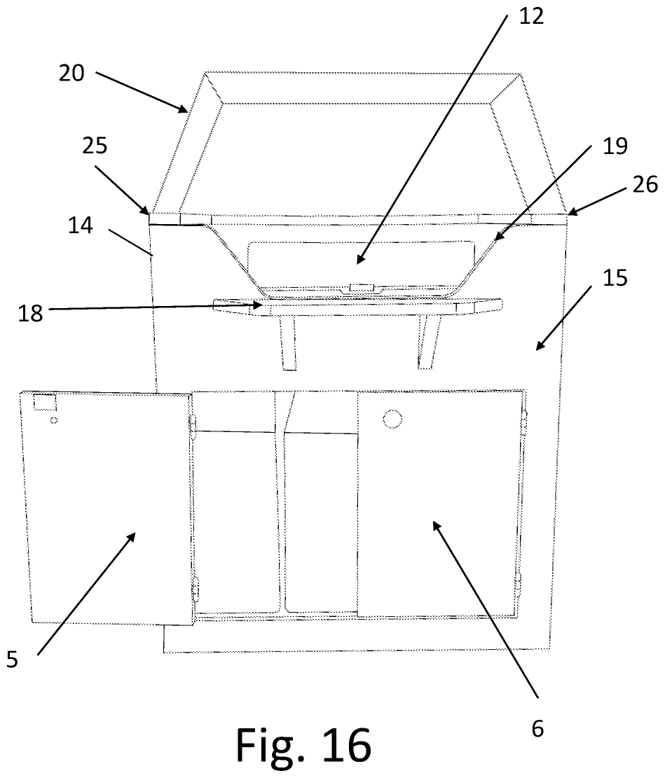

Now referring to FIGS. 16-18, a protective shield 20 may be added to go up and around the top three sides — still providing an open, raised access. FIGS. 16-18 show another alternative embodiment of the present invention where the open top of the box has walls 21, 22, 23 attached to the sides and back semi-enclosing the litter box or a hood 24 with a side or top entry location. Additional walls 21, 22, 23 or a hood 24 can be removably attached to the top sides of the side walls 25 and 26 and back wall 4 to provide for litter control and/or privacy.

In an alternative embodiment, the bottom may also be configured to act as a slide-out. In this embodiment, similar hardware used to enable the top lids to slide is used. The slide-out bottom can also be further equipped with soft closing sliding hardware.

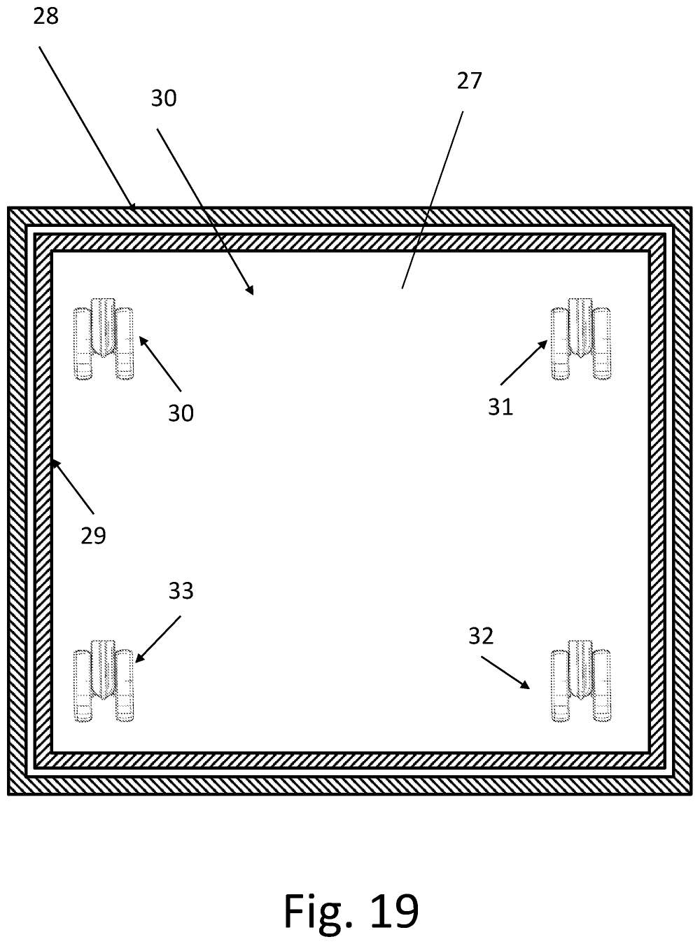

FIG. 19 illustrates the lower underside portion 35 of the modular litter box system where trim 28 is attached the walls 29 to create a recess 30 with the underside of the box floor 27 for adding a plurality of wheels 31, 32, 33, 34 and to create a matching recess to the outer top surface of the modular litter box system so that they can be placed in a stacked position.

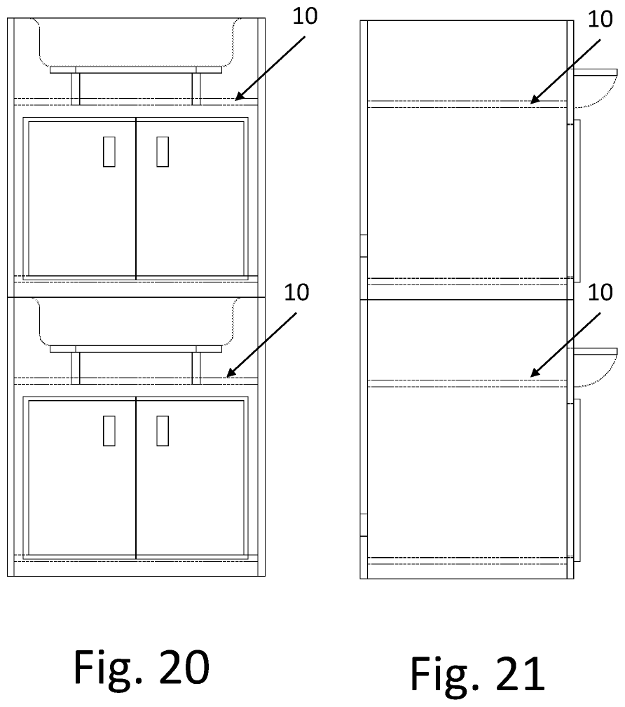

FIGS. 20-21 illustrate the modular litter box system in a two stack arrangement. Here either of the embodiments may have the bottom trim 228 attached to create a recess 30 as shown in FIG. 19 that can fit over the top surfaces of another box to enable stacking or modularity to design for multiple combinations. In these combinations, doors 5 and 6 may be removed or retained, as well as the fold out perch 13 may be left in an open position or stored in a closed/internal position out of the way if desired or the fixed perch 18 as illustrated may remain attached or removed.

In an alternative embodiment, a molded, sprayed permanent, and/or replaceable cat-friendly material can be lasered cut, fabricated, and glued or sprayed to adhere to the inside and outer edges of the box/perch.

In yet another alternative embodiment, cat friendly material can be used inside the box so that it can be used to replace the cat litter box.

In addition to the acrylic-like protection, the box can also store a common cat litter box to be placed into the “pocket” or recessed area of the box.

As illustrated, the present invention is designed to be compatible with standard cat litter boxes currently available with respect to size and shape. In the drawings various versions of cat litter boxes have been used to illustrate this compatibility.

The present invention is specifically measured and designed to allow all users to be able to store and use any type of litter box, standard small trash bin, store new litter, as well as utilities needed to keep a tidy litter area for small living spaces.

The present invention teaches a raised, elevated off the ground open litter box allowing owners an easy way to keep it clean and concealed without much physical movement, such as bending over or kneeling.

Thus, the device is appreciated that the optimum dimensional relationships for the parts of the invention, to include variation in size, materials, shape, form, function, and manner of operation, assembly, and use, are deemed readily apparent and obvious to one of ordinary skill in the art, and all equivalent relationships to those illustrated in the drawings and described in the above description are intended to be encompassed by the present invention.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A raised cat litter box storage device, comprising:
a modular furniture solution for raising a litter box to a higher level the modular furniture component comprised of:
a front wall with two door openings,
two solid side walls,
a solid bottom,
a rear wall with cut out for electrical cords, and
front double doors swinging open from the center with each respective door being hinged to the nearest adjacent side wall; and
a single internal shelf located approximately halfway up the back and side walls.

2. The raised cat litter device of claim 1, wherein
the shelf creates a recessed flat or floor surface for the placement of a litter box.

3. The raised cat litter device of claim 2, wherein
the shelf is manufactured in a fixed or adjustable location.

4. The raised cat litter device of claim 1, wherein
when the doors are open, access is provided to a lower shelf area, which is sealed off when the doors are in a closed position, creating an area for storage.

5. The raised cat litter device of claim 1, further comprising
wheels allowing easy movement for cleaning or re-positioning.

6. The raised cat litter device of claim 1, further comprising
two top doors that are hinged and can be rotated to an open position creating an animal perch and open access to the litter box located on the internal single shelf.

7. The raised cat litter device of claim 6, wherein
one of the top two doors is removed and the remaining door is placed into an open position creating an animal perch and open access to the litter box located on the internal single shelf.

8. The raised cat litter device of claim 1, wherein
the internal single shelf raises a standard sized litter box up and off the floor by at least two (2) feet.

9. A raised cat litter box storage device, comprising:
a front wall with two door openings;
two solid side walls,
a solid bottom,
a rear wall with small cut out for cords,
a single shelf is located approximately halfway up the back and side walls;
two front double doors swinging open from the center with each respective door being hinged to the nearest adjacent side wall, and
two top double doors swinging open from the center with each respective door being hinged to the nearest adjacent side wall creating an animal perch and open access to the litter box located on the internal single shelf

10. The raised cat litter device of claim 9, wherein
the top doors are hinged and removably attached.

11. The raised cat litter device of claim 9, further comprising
a foldable front perch is attached to the front wall of the box using a hinge and
is folded or rotated out for use as a perch for an animal, or
stored to allow the unit to be stacked with another until in an alternative embodiment; and
the front perch, like the top doors is attached is a manner, like a hinge or piano hinge that also allows for quick detachment and removal.

12. The raised cat litter device of claim 9, wherein
with one top door in an open position acting as a perch for the animal and the other top door removed, and
either of the top doors can be removed individually or as a pair.

13. The raised cat litter device of claim 9, wherein
both top doors placed in an open position acting as perches for an animal creating a raised litter box, with one or more perches for an animal providing open access to the litter box in an elevated or raised position off the floor.

14. The raised cat litter device of claim 9, wherein
both top doors in an open position creating an animal perch and open access to the litter box located on the internal single shelf, and
the hinged perch in an open or external position creating an animal perch and open access to the litter box located on the internal single shelf.

15. The raised cat litter device of claim 9, wherein
both top doors are removed, and
the hinged perch in an open or external position allowing open access to the litter box by an animal or a user and creating an animal perch and open access to the litter box located on the internal single shelf.

16. The raised cat litter device of claim 9, wherein
both top doors are removed,
the hinged perch in a closed/internal position or removed; and
the front perch can be placed or left in a closed or internal position or removed completely.

17. A raised cat litter box storage device, comprising:
a front wall with two door openings;
two solid side walls,
a solid bottom,
a rear wall with small cut out for cords,
a single shelf is located approximately halfway up the back and side walls;
two front double doors swinging open from the center with each respective door being hinged to the nearest adjacent side wall, and
the front wall having a cut out portion above the single shelf allowing front access to a litter box, and
a fixed position perch secured to the front wall just below the cut out portion creating a perch for an animal or a work shelf for the litter box.

18. The raised cat litter device of claim 17, further comprising
a protective shield up and around the top three sides providing an open, raised access litter box.

19. The raised cat litter device of claim 17, whereon
the open top of the box has walls attached to the sides and back semi-enclosing the litter box or a hood with a side or top entry location;
the additional walls or a hood is removably attached to the top sides of the side walls and back wall to provide for litter control and/or privacy.

20. The raised cat litter device of claim 17, wherein
the lower underside portion of the modular litter box system where trim is attached the walls to create a recess for
adding a plurality of wheels, and
to create a matching recess to the outer top surface of the modular litter box system so that they can be placed in a stacked position.
